(19) United States
(12) Patent Application Publication
(10) Pub. No.: US 2016/0219324 A1
(43) Pub. Date: Jul. 28, 2016

(54) SMARTPHONE TELEVISION

(71) Applicant: COREMATE TECHNICAL CO., LTD., Taoyuan County (TW)

(72) Inventor: Robert Wang, Taoyuan County (TW)

(21) Appl. No.: 14/607,305

(22) Filed: Jan. 28, 2015

(51) Int. Cl. H04N 21/41; H04N 7/18; H04N 21/4363; H04N 21/4223; H04N 21/422; H04N 21/418

(52) U.S. Cl. CPC H04N 21/4126; H04N 21/4222; H04N 21/4182; H04N 21/42221; H04N 21/42224; H04N 21/43632; H04N 21/4223; H04N 7/186

(57) ABSTRACT

A smartphone television includes a display. The display is connected with a television mobile audio and video communication device. The television mobile audio and video communication device includes a built-in SIM (Subscriber Identity Module) and a mobile communication device. The television mobile audio and video communication device is connected with a phone. The phone is provided with a touch panel. Thereby, the phone is connected with the television mobile audio and video communication device through, such that the phone is connected with the SIM and the mobile communication device for talking by using the phone. The television mobile audio and video communication device is remotely operated by using the touch panel of the phone to control the audio and video broadcast of the display so as to integrate the phone and the television.

### BACKGROUND OF THE INVENTION

1. Field of the Invention

The present invention relates to a smart electric appliance, and more particularly to a smartphone television.

2. Description of the Prior Art

With the development of technology, the industry environment and the demand and development of the market are changed accordingly. Nowadays, integration of electric appliances has become the current intend of industry and market.

In general, TV becomes one of the essential electrical appliances for each family, and its utilization rate is high relative to other home electrical appliances. However, a conventional TV has basic video and audio broadcast and is provided with an external broadcast device, which doesn't have any further breakthrough.

The function of the television cannot be diversified. A traditional indoor phone is widely used, but it cannot meet the current trend of digital electric appliances and won't satisfy the user.

Accordingly, the inventor of the present invention has devoted himself based on his many years of practical experiences to solve these problems.

### SUMMARY OF THE INVENTION

The primary object of the present invention is to provide a smartphone television which combines a phone with a television to become a whole. The present invention provides an innovated television capable of hearing, watching, and speaking.

In order to achieve the aforesaid object, the smartphone television of the present invention comprises a display, a television mobile audio and video communication device, and a phone. The television mobile audio and video communication device is connected with the display. The television mobile audio and video communication device comprises a built-in television module and a built-in SIM (Subscriber Identity Module). The television mobile audio and video communication device further comprises a wireless power supply seat and a mobile communication device. The television module is adapted for the display to broadcast. The SIM, the wireless power supply seat, and the mobile communication device are connected to a first processor, respectively. The first processor is further connected with a first wireless transmission device. The phone is selectively disposed on the wireless power supply seat of the television mobile audio and video communication device. The phone is provided with a radio device and a broadcast device. The front of the phone is provided with a touch panel. The phone comprises a wireless charging device and a television remote-controlled module therein. The television remote-controlled module is connected with the touch panel. The radio device, the broadcast device, the touch panel, the wireless charging device, and the television remote-controlled module are connected with a second processor, respectively. The second processor is further connected with a second wireless transmission device.

The smartphone television of the present invention uses the second wireless transmission device of the phone to connect with the first wireless transmission device of the television mobile audio and video communication device for the phone to connect with the SIM as well as the mobile communication device so that the user can talk by using the phone. At the same time, the television mobile audio and video communication device can be remotely operated by using the touch panel of the phone to control the audio and video broadcast of the display. The functions of the phone and television can be integrated. The present invention provides an innovated television capable of hearing, watching, and speaking.

### BRIEF DESCRIPTION OF THE DRAWINGS

FIG. 1 is a schematic view of the present invention;

FIG. 2 is a schematic view of the present invention when in use;

FIG. 3 is a block diagram of the present invention;

FIG. 4 is a schematic view of the present invention when in use, providing a telephone function;

FIG. 5 is another schematic view of the present invention when in use, providing a television remote control function; and

FIG. 6 is a further schematic view of the present invention when in use, providing an air flying squirrel function.

### DETAILED DESCRIPTION OF THE PREFERRED EMBODIMENTS

Embodiments of the present invention will now be described, by way of example only, with reference to the accompanying drawings.

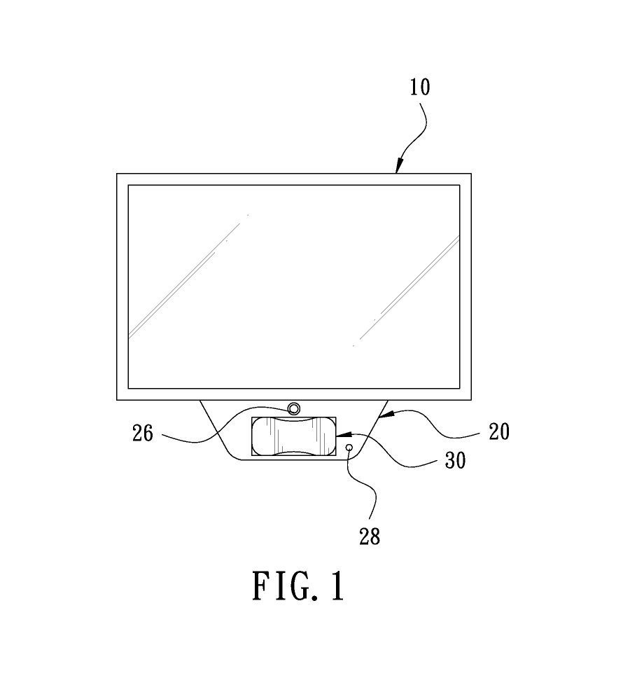

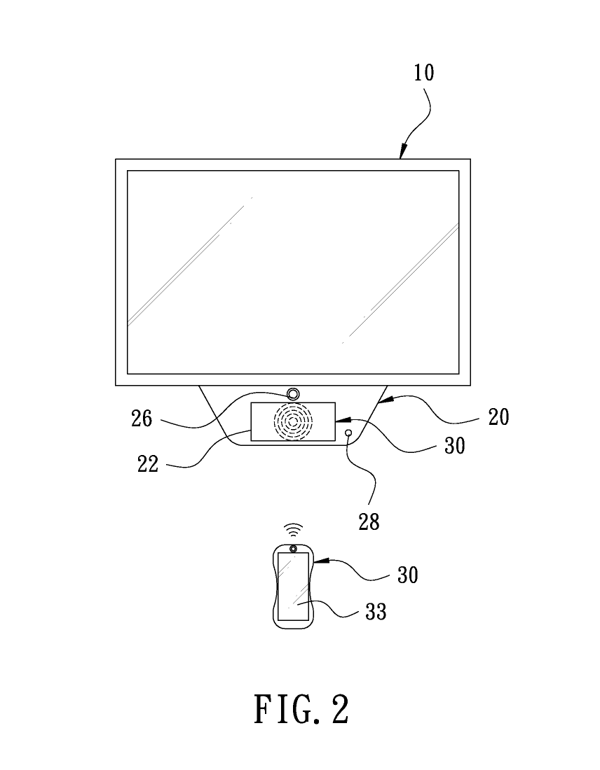

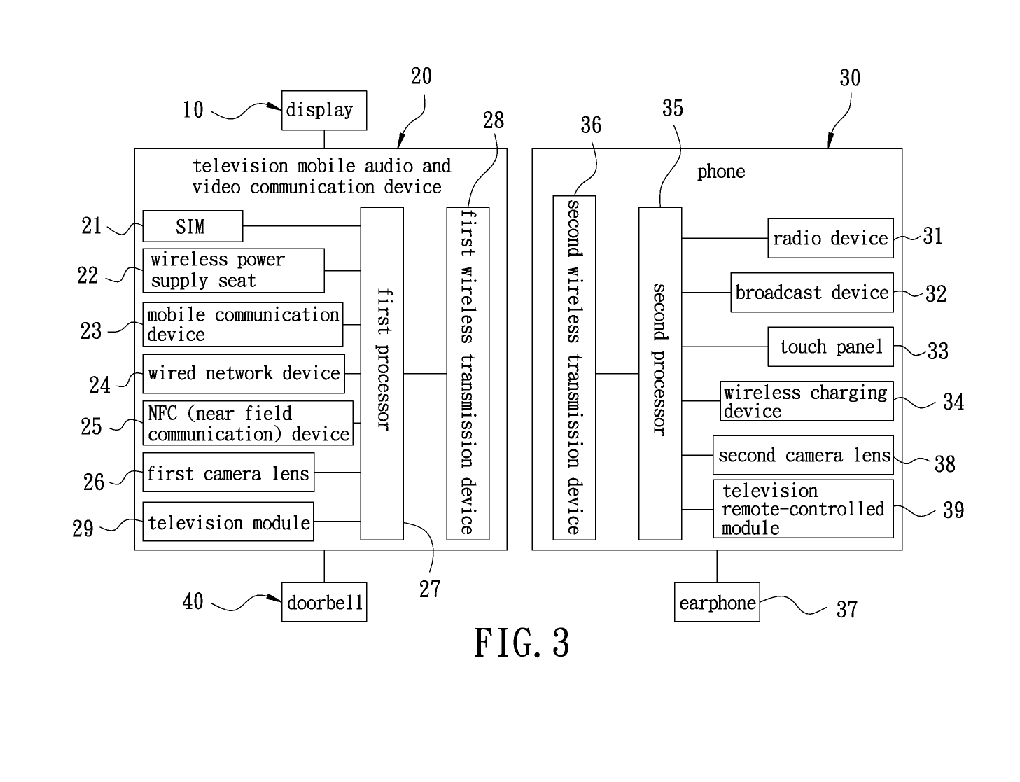

FIG. 1 is a schematic view of the present invention. FIG. 2 is a schematic view of the present invention when in use. FIG. 3 is a block diagram of the present invention. The present invention discloses a smartphone television. The smartphone television comprises a display 10, a television mobile audio and video communication device 20, and a phone 30.

In the present invention, the display 10 may be a liquid crystal display for showing video signals.

The television mobile audio and video communication device 20 is connected with the display 10. The television mobile audio and video communication device 20 comprises a built-in television module 29 and a built-in SIM (Subscriber Identity Module) 21. The television mobile audio and video communication device 20 further comprises a wireless power supply seat 22, a mobile communication device 23, a wired network device 24, a NFC (near field communication) device 25, and a first camera lens 26. The wireless power supply seat 22, the mobile communication device 23, the wired network device 24, the NFC device 25, and the first camera lens 26 are connected with a first processor 27, respectively. The first processor 27 is further connected with a first wireless transmission device 28. The television module 29 is adapted for the display 10 to broadcast a program. The wireless power supply seat 22 is adapted to supply power to an external device in a wireless transmission way. The mobile communication device 23 is adapted for the television mobile audio and video communication device 20 to transmit data wirelessly at a high speed.

In the present invention, the mobile communication device 23 may be a 3G or 4G mobile communication device. The wired network device 24 is adapted for the television mobile audio and video communication device 20 to transmit data by a network transmission cable. The NFC device 25 is adapted for the television mobile audio and video communication device 20 to receive and transmit wireless signals in low-frequency band. The first camera lens 26 is disposed at the front of the television mobile audio and video communication device 20 for video communication. The television mobile audio and video communication device 20 is further connected with a doorbell 40.

The phone 30 is selectively disposed on the wireless power supply seat 22 of the television mobile audio and video communication device 20. The phone 30 is provided with a radio device 31, a broadcast device 32, a touch panel 33, a wireless charging device 34, and a television remote-controlled module 39. The radio device 31, the broadcast device 32, the touch panel 33, the wireless charging device 34, and the television remote-controlled module 39 are connected with a second processor 35, respectively. The second processor 35 is further connected with a second wireless transmission device 36. The touch panel 33 is adapted for touch operations. The television remote-controlled module 39 is connected with the touch panel 33 for the user to operate the television remote-controlled module 39 through the touch panel 33, such that the television module 29 is controlled through the television remote-controlled module 39. The wireless charging device 34 is adapted for the phone 30 to be charged when the phone 30 is placed on the wireless power supply seat 22 of the television mobile audio and video communication device 20. When in use, the phone 30 is connected with the first wireless transmission device 28 of the television mobile audio and video communication device 20 through the second wireless transmission device 36 for data to be transmitted in a wireless way. In the present invention, the second wireless transmission device 36 is an infrared transmitter and the first wireless transmission device 28 is an infrared receiver, such that the phone 30 and the television mobile audio and video communication device 20 can carry out wireless transmission and connection by means of infrared rays. The phone 30 is further provided with a second camera lens 38. The second camera lens 38 is connected with the second processor 35 for video communication. Besides, the phone 30 is externally connected with an earphone 37 for the user to operate the touch panel 33 when he/she talks on the phone.

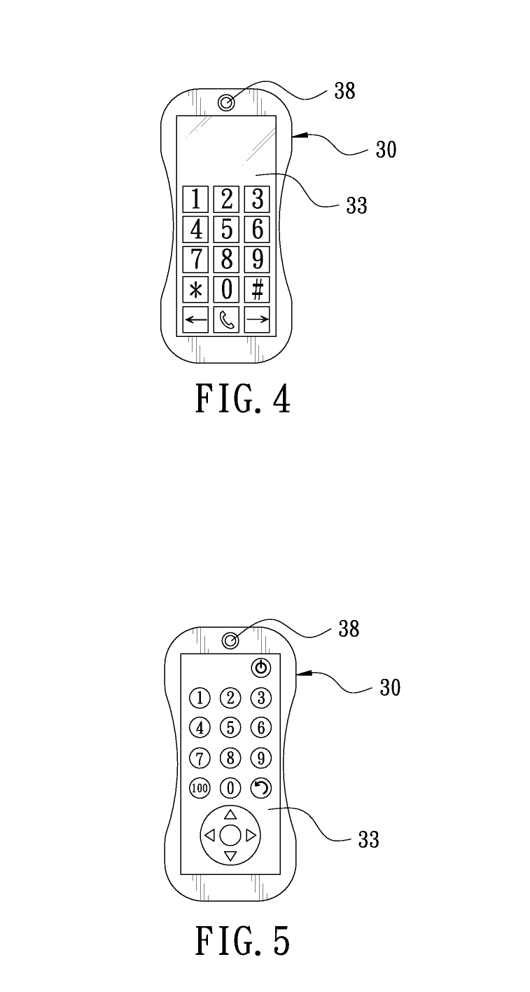

FIG. 4 is a schematic view showing the phone of the present invention when in use. Referring to FIG. 2 and FIG. 3, when the smartphone television is operated by the user, through the built-in program of the phone 30, the touch panel 33 of the phone 30 will show the telephone keys for the user to operate by touch. The second wireless transmission device 36 of the phone 30 is connected with the first wireless transmission device 28 of the television mobile audio and video communication device 20 for the phone 30 to be connected with the SIM 21 and the mobile communication device 23, such that the user can talk by using the phone 30. It is noted that the phone 30 is connected with the first wireless transmission device 28 of the television mobile audio and video communication device 20 through the second wireless transmission device 36 in a wireless way. Thus, when in use, the phone 30 is not limited to the surroundings of the television mobile audio and video communication device 20, it can carry out its communication function throughout the house.

Referring to FIG. 1 and FIG. 3, after use, the user can place the phone 3 on the wireless power supply seat 22 of the television mobile audio and video communication device 20 again, enabling the wireless charging device 34 of the phone 30 to correspond to the wireless power supply seat 22 of the television mobile audio and video communication device 20 so as to be charged for supplying the required electricity to the phone 30.

FIG. 5 is another schematic view showing the phone of the present invention when in use. Referring to FIG. 2 and FIG. 3, the smartphone television uses the built-in program of the phone 30 for the touch panel 33 of the phone 30 to show the television remote-controlled keys so that the user can operate the television remote-controlled module 39. At this time, the second wireless transmission device 36 of the phone 30 is connected with the first wireless transmission device 28 of the television mobile audio and video communication device 20, so that the phone 30 is connected with the television mobile audio and video communication device 20. Thus, the user can use the touch panel 33 of the phone 30 and the television remote-controlled module 39 to remotely operate the television mobile audio and video communication device 20 as to control the display 10 to carry out audio and video broadcast of the television.

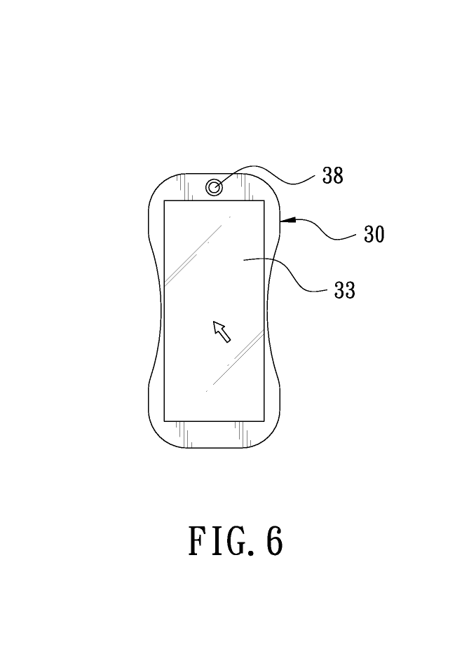

FIG. 6 is a further schematic view showing the phone of the present invention when in use. Referring to FIG. 2 and FIG. 3, the smartphone television uses the built-in program of the phone 30 for the touch panel 33 of the phone 30 to carry out wireless air flying squirrel functions. At this time, the second wireless transmission device 36 of the phone 30 is connected with the first wireless transmission device 28 of the television mobile audio and video communication device 20, so that the phone 30 is connected with the television mobile audio and video communication device 20. Thus, the user can use the touch panel 33 of the phone 30 to remotely operate the television mobile audio and video communication device 20.

It is noted that the television mobile audio and video communication device 20 is further connected with the doorbell 40. When the user presses the doorbell 40, the television mobile audio and video communication device 20 makes the display 10 show the surveillance image of the doorbell 40, such that the smartphone television can be further connected with the doorbell.

The features and expected effects of the present invention are described hereinafter.

The smartphone television of the present invention uses the second wireless transmission device 36 of the phone 30 to connect with the first wireless transmission device 28 of the television mobile audio and video communication device 20 for the phone 30 to connect with the SIM 21 as well as the mobile communication device 23 so that the user can talk by using the phone 30. At the same time, the television mobile audio and video communication device 20 can be remotely operated by using the touch panel 33 of the phone 30 so as to control the audio and video broadcast of the display 10. The functions of the phone and television can be integrated. The present invention provides an innovated television capable of hearing, watching, and speaking.

Although particular embodiments of the present invention have been described in detail for purposes of illustration, various modifications and enhancements may be made without departing from the spirit and scope of the present invention. Accordingly, the present invention is not to be limited except as by the appended claims.

1. A smartphone television, comprising:
a display;
a television mobile audio and video communication device connected with the display, the television mobile audio and video communication device comprising a built-in television module and a built-in SIM (Subscriber Identity Module), the television mobile audio and video communication device further comprising a wireless power supply seat and a mobile communication device, the television module being connected to the display to broadcast, the SIM, the wireless power supply seat, and the mobile communication device being respectively connected to a first processor, the first processor being further connected with a first wireless transmission device; and
a phone selectively disposed on the wireless power supply seat of the television mobile audio and video communication device, the phone being provided with a radio device and a broadcast device, a front side of the phone being provided with a touch panel, the phone comprising a wireless charging device and a television remote-controlled module therein, the television remote-controlled module being connected with the touch panel, the radio device, the broadcast device, the touch panel, the wireless charging device, and the television remote-controlled module being respectively connected with a second processor, the second processor being further connected with a second wireless transmission device, the television mobile audio and video communication device further comprises a wired network device, and the wired network device is connected with the first processor; the television mobile audio and video communication device further comprises a NFC (near field communication) device, and the NFC device is connected with the first processor, the television mobile audio and video communication device is connected with a doorbell;
thereby, the phone being connected with the first wireless transmission device of the television mobile audio and video communication device through the second wireless transmission device for talking by using the phone, the television mobile audio and video communication device being remotely operated by using the touch panel of the phone to control audio and video broadcast of the display.

2. (canceled)

3. (canceled)

4. The smartphone television as claimed in claim 1, wherein the television mobile audio and video communication device further comprises a first camera lens, and the first camera lens is connected with the first processor.

5. (canceled)

6. The smartphone television as claimed in claim 4-4, wherein the phone is further provided with a second camera lens, and the second camera lens is connected with the second processor.

7. The smartphone television as claimed in claim 1, wherein the phone is externally connected with an earphone.

8. The smartphone television as claimed in claim 1, wherein the display is a liquid crystal display.
